(19) United States
(12) Patent Application Publication
(10) Pub. No.: US 2015/0237050 A1
(43) Pub. Date: Aug. 20, 2015

(54) APPARATUS AND METHOD FOR PROVIDING HOME NETWORK ACCESS CONTROL

(71) Applicant: Electronics and Telecommunications Research Institute, Daejeon (KR)

(72) Inventors: Hark-Jin LEE, Daejeon (KR); Jun-Hee PARK, Daejeon (KR); Ji-Yeon SON, Daejeon (KR); Eun-Seo LEE, Daejeon (KR)

(21) Appl. No.: 14/458,166

(22) Filed: Aug. 12, 2014

(30) Foreign Application Priority Data
Feb. 17, 2014 (KR) 10-2014-0017946

(51) Int. Cl. H04L 29/06; H04L 29/08

(52) U.S. Cl. CPC H04L 63/0884; H04L 67/10; H04L 63/101; H04L 63/06; H04L 63/062

(57) ABSTRACT

The present invention relates to controlling of an access for a device on home network middleware. The access control apparatus includes: an access control manager, a virtual device and a virtual device manager. The access control manager manages a list of authentication codes including an authorization level and authentication code for the device and a client requesting a service to the device; controls the access for the device by authenticating the client based on the list of authentication codes and checking whether the device control request is suitable for the authorization level of the client. The virtual device is generated in correspondence with the device to store device information and an encryption key required for encrypted communication with the device. The virtual device manager manages the virtual device corresponding to the device by checking the device periodically.

### CROSS-REFERENCE TO RELATED APPLICATIONS

This application claims the benefit of Korean Patent Application No. 10-2014-0017946, filed with the Korean Intellectual Property Office on Feb. 17, 2014, the disclosure of which is incorporated herein by reference in its entirety.

### BACKGROUND

1. Technical Field

The present invention relates to an apparatus and a method for controlling an access between a device and a client on a home network middleware, more specifically to an apparatus and a method for home network access control that not only restrict the range of functions provided by the device but also provide encrypted device information according to an authorization level of the client.

2. Background Art

With the recent increase and technological advancement in the number of home network supportable devices, there has been conversion to a ubiquitous environment that allows access to device information from everywhere. With the introduction of the home network environment, services can access the computing environment using various devices at any time, and the computing environment can recognize and assess surrounding environments and provide useful services to man, similarly to humans, who have intelligence, communicating and making decisions based on information about the surrounding environments.

Accordingly, there have been active studies on an access control model for various devices in the computing service environment of the home network environment. Unlike the conventional security services for which authorization used to be authenticated simply with service information, the access control model in the home network environment needs to restrict the range of the functions (or information) provided by the devices according to the level of service (client).

### SUMMARY

The present invention provides an apparatus and a method for controlling home network access that can control the range of functions provided by a device according to a level of authorization of a client in a home network environment.

Moreover, the present invention provides an apparatus and a method for controlling home network access that can perform access control efficiently by centrally managing access control information for various devices in a home network environment.

An aspect of the present invention features an apparatus for controlling an access for a device on a home network. The apparatus for access control of a home network in accordance with an embodiment of the present invention includes: an access control manager configured to manage a list of authentication codes including an authorization level and authentication code configured for the device and a client requesting a service to the device and configured to control the access for the device by authenticating the client based on the list of authentication codes, when a device control request is received from the client, and checking whether the device control request is suitable for the authorization level of the client; a virtual device generated in correspondence with the device and configured to store device information and an encryption key required for encrypted communication with the device; and a virtual device manager configured to manage the virtual device corresponding to the device by checking the device periodically.

In an embodiment, the authorization level and the authentication code of the device and the client can be configured by a security administrator.

In an embodiment, the access control manager can be configured to generate a virtual device corresponding to a device registration request when the device registration request is received from the device, generate and store a first encryption key for encrypted communication with the device in the virtual device, and transfer the first encryption key to the device.

In an embodiment, the access control manager can be configured to generate a second encryption key for use between the client and the access control apparatus when a client registration request is received from the client and transfer the second encryption key to the client.

In an embodiment, if the device control request received from the client is verified to be a control request made by an authenticated client having a suitable authorization level, the access control manager can be configured to control the device through the corresponding virtual device, receive a control result from the device, and encrypt and transfer the control result to the client.

Another aspect of the present invention features a method for controlling an access for a device on a home network. The method for controlling an access for a device on a home network in accordance with an embodiment of the present invention includes: storing a list of authentication codes including an authorization level and an authentication code configured for the device and a client requesting a service to the device; receiving a device control request from the client; authenticating the client having requested the device control request based on the list of authentication codes and verifying whether the device control request made by the client is suitable for the authorization level of the client; transferring the control request to the requested device if the device control request made by the client is verified to be suitable for the authorization level of the client; and receiving a control result for the control request from the device and transferring the control result to the client.

In an embodiment, once a device registration request is received from the device, the method can further include: receiving the authentication code and the authorization level for the device from a security administrator; generating a virtual device corresponding to the device; generating a first encryption key for encrypted communication with the device; storing the first encryption key in the virtual device; and transferring the first encryption key to the device.

In an embodiment, the transferring of the control request to the requested device can include encrypting and transferring the control request by use of the first encryption key stored in the virtual device corresponding to the requested device.

In an embodiment, once a client registration request is received from the client, the method can further include: receiving the authentication code and the authorization level for the client from a security administrator; generating a second encryption key for encrypted communication with the client; and transferring the second encryption key to the client.

In an embodiment, the step of receiving a control result for the control request from the device and transferring the control result to the client can include encrypting the control result by use of the second encryption key and transferring the control result to the client.

With the embodiments of the present invention, it becomes possible to prevent unauthorized device control by a client by providing device information suitable for the authorization level of the client and provide safe home network services by allowing the client to control the device with a suitable authorization level.

Moreover, by using lightweight encryption between an access control apparatus and a device, it becomes possible to reduce the burden that the device has for encryption.

### BRIEF DESCRIPTION OF THE DRAWINGS

FIG. 1 is a block diagram illustrating the configuration of an apparatus for providing home network access control in accordance with an embodiment of the present invention.

FIG. 2 shows how a device is registered in accordance with an embodiment of the present invention.

FIG. 3 shows how a client is registered in accordance with an embodiment of the present invention.

FIG. 4 shows how home network access is controlled in accordance with an embodiment of the present invention.

FIG. 5 is a block diagram illustrating the configuration of a computing system for implementing the apparatus for providing home network access control in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain relevant conventional technology is determined to evade the point of the present invention, the pertinent detailed description will be omitted.

Unless otherwise stated, any expression in singular form in the description and the claims shall be interpreted to generally mean “one or more.”

Moreover, any terms “module,” “unit,” “interface,” etc. used in the description shall generally mean computer-related objects and can mean, for example, hardware, software and a combination thereof.

Hereinafter, certain embodiments of the present invention will be described in detail with reference to the accompanying drawings.

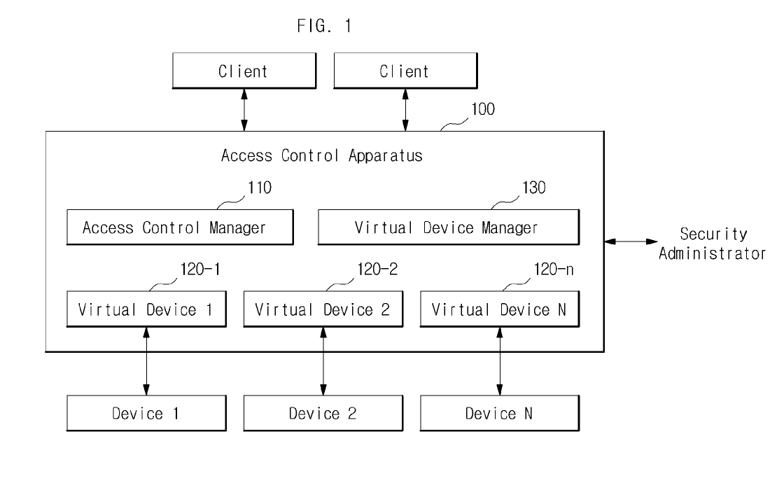

FIG. 1 is a block diagram illustrating the configuration of an apparatus for providing home network access control in accordance with an embodiment of the present invention.

In an embodiment, the access control apparatus 100 can include an access control manager 110, virtual devices 120-1, . . . , 120-n, and a virtual device manager 130.

The access control manager 110 manages a list of authentication codes that includes authorization levels and authentication codes configured for devices that are present in a home network and clients (or users) requesting the devices for services.

In an embodiment, the authorization levels and authentication codes of the devices and the clients can be configured (inputted) by a security administrator during a registration procedure of the devices and the clients.

Once a request for registration of a device is received from the device on the home network, the access control manager 110 generates a virtual device 120-1, . . . , 120-n corresponding to the received request for registration, generates and stores a first encryption key for encrypted communication with the device in the generated corresponding virtual device, and transfers the first encryption key to the device as well.

Communication between the access control device and the devices is made through an in-house network and thus has little possibility of exposure to an outside. Accordingly, the access control device 100 and the devices are encrypted based on a light encryption algorithm, such as a secret key encryption method or a hash authentication method, rather than by an open-key-based authentication method, which has a complex encryption process.

Moreover, once a request for registration of a client is received by the client, the access control manager 110 generates and stores a second encryption key for use between the client and the access control device in a local storage and also transfers the generated second encryption key to the client.

Once a request for control of a device is received from a particular client, the access control manager 110 can control an access to the device by checking whether the client is an authenticated client based on the list of authentication codes and whether the request for control of the device is suitable for the authorization level of the client. In the case where it is checked that the request for control of the device received from the client is from an authenticated client having a proper authorization level, the access control manager 110 controls the device through a corresponding virtual device, receives a result from the control from the device, and encrypts and transfers the result to the client using the second encryption key.

In an embodiment, the communication between the device and the access control apparatus 100 can be an encrypted communication using the first encryption key, and communication between the client and the access control apparatus 100 can be an encrypted communication using the second encryption key.

The virtual device 120-1, . . . , 120-n is generated corresponding to each device during an initial process in which the devices on the home network are connecting to the network, and stores the corresponding device information and the first encryption key required for encrypted communication with the device.

Here, the first encryption key is merely a collective term for the purpose of distinguishing from the second encryption key, which is used for encrypted communication between the access control apparatus 100, and in reality, a different encryption key is generated for each device and will be stored in the corresponding virtual device. It shall be appreciated by anyone of ordinary skill in the art that, in the case of the second encryption key, a different encryption key can be generated and stored for each service when the client (user) requests for registration.

The virtual device manager 130 can check the state of the devices on the home network periodically and manage the virtual devices corresponding to the devices.

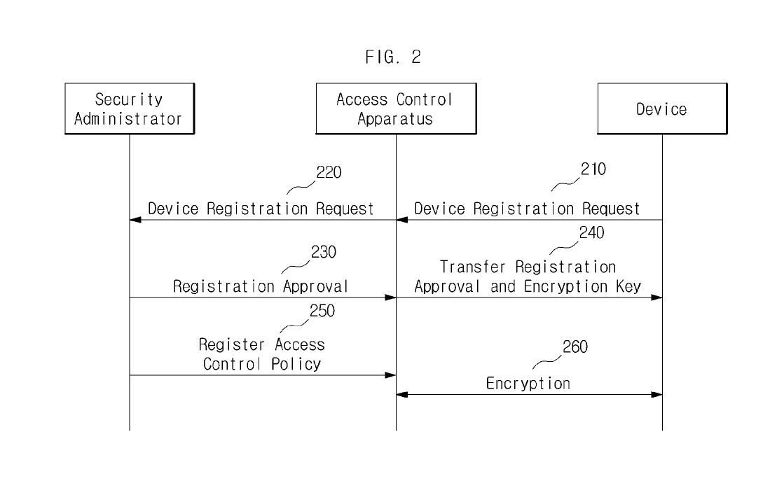

FIG. 2 shows how a device is registered in accordance with an embodiment of the present invention.

When the device accesses a home network initially, the device transmits a device registration request to an access control apparatus (210). Here, the device registration request can include device information.

The access control apparatus transfers the device registration request to a security administrator (220) and receives a registration approval (230).

Once the registration approval is received from the security administrator, the access control apparatus generates a virtual device corresponding to the device, and generates and transfers a first encryption key, for use between the device and the virtual device, to the device (240). The first encryption key will be stored in the virtual device, together with the device information.

Moreover, the security administrator can register an access control policy, which includes an authentication code and/or an authorization level for the device, in the access control apparatus (250).

Afterwards, an encrypted communication using the first encryption key can be carried out between the access control apparatus and the device (260).

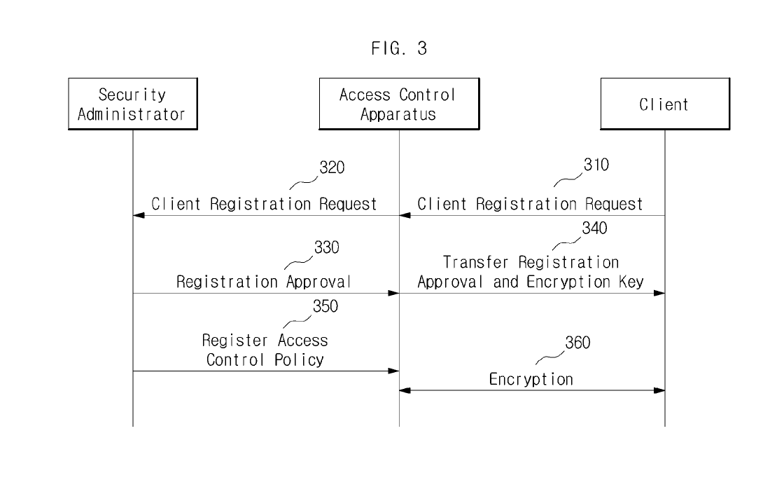

FIG. 3 shows how a client is registered in accordance with an embodiment of the present invention.

When the client accesses the home network initially, the client transmits a client registration request to the access control apparatus (310).

The access control apparatus transfers the client registration request to the security administrator (320) and receives a registration approval from the security administrator (330). Once the registration approval is received, the access control apparatus generates and transfer a second encryption key, for use between the registration-requested client and the access control apparatus, to the client (340).

Moreover, the security administrator can register an access control policy, which includes an authentication code and an authorization level for the client, in the access control apparatus (350).

Afterwards, an encrypted communication using the second encryption key can be carried out between the access control apparatus and the client (360).

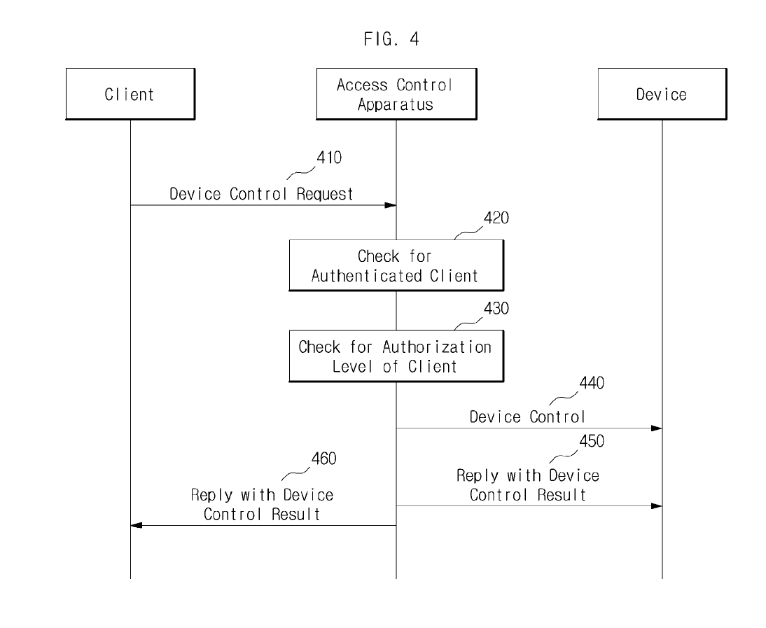

FIG. 4 shows how home network access is controlled in accordance with an embodiment of the present invention.

As illustrated, when the access control apparatus receives a device control request from the client (410), the access control apparatus authenticates the client that transmitted the device control request based on a list of authentication codes (420) and checks whether the device control request of the client is a valid control request according to the authorization level of the client (430). In an embodiment, the list of authentication codes is a list for managing authorization levels and authentication codes for devices and clients registered on the home network.

Once the device control request is determined to be a valid control request for the authorization level, the access control apparatus transfers the control request to the requested device (440).

The access control apparatus can receive a control result for the control request from the device (450) and transfer the control request to the client (460).

Here, the device control request can be transferred by being encrypted using an encryption key stored in a virtual device corresponding to the device, and the result thereof can be received by also being encrypted using the same encryption key. In the meantime, the result will be transferred to a service by being encrypted using the encryption key configured for the client.

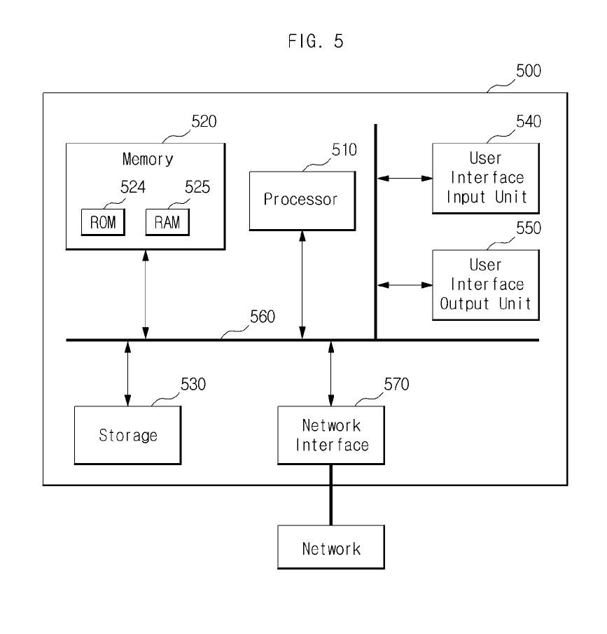

FIG. 5 is a block diagram illustrating the configuration of a computing system for implementing the apparatus for providing home network access control in accordance with an embodiment of the present invention. An embodiment of the present invention can be implemented as, for example, a computer-readable recording medium, in a computer system.

As shown in in FIG. 5, a computer system 500 may include one or more of a processor 510, a memory 520, storage 530, a user interface input unit 540, and a user interface output unit 550, each of which communicates through a bus 560. The computer system 500 may also include a network interface 570 that is coupled to a network. The processor 510 may be a central processing unit (CPU) or a semiconductor device that executes processing instructions stored in the memory 520 and/or the storage 530. The memory 520 and the storage 530 may include various forms of volatile or non-volatile storage media. For example, the memory may include a read-only memory (ROM) 524 and a random access memory (RAM) 525.

Accordingly, an embodiment of the invention may be implemented as a computer-implemented method or as a non-transitory computer readable medium with computer executable instructions stored thereon. In an embodiment, when executed by the processor, the computer readable instructions may perform a method according to at least one aspect of the invention.

The program instructions stored in the computer readable medium can be designed and configured specifically for the present invention or can be publically known and available to those who are skilled in the field of software. Examples of the computer readable medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above hardware devices can be configured to operate as one or more software modules in order to perform the operation of the present invention, and the opposite is also possible.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. An apparatus for controlling an access for a device on a home network, comprising:
an access control manager configured to manage a list of authentication codes including an authorization level and authentication code configured for the device and a client requesting a service to the device and configured to control the access for the device by authenticating the client based on the list of authentication codes, when a device control request is received from the client, and checking whether the device control request is suitable for the authorization level of the client;
a virtual device generated in correspondence with the device and configured to store device information and an encryption key required for encrypted communication with the device; and
a virtual device manager configured to manage the virtual device corresponding to the device by checking the device periodically.

2. The apparatus of claim 1, wherein the authorization level and the authentication code of the device and the client are configured by a security administrator.

3. The apparatus of claim 1, wherein the access control manager is configured to generate a virtual device corresponding to a device registration request when the device registration request is received from the device, generate and store a first encryption key for encrypted communication with the device in the virtual device, and transfer the first encryption key to the device.

4. The apparatus of claim 1, wherein the access control manager is configured to generate a second encryption key for use between the client and the access control apparatus when a client registration request is received from the client and transfer the second encryption key to the client.

5. The apparatus of claim 1, wherein, if the device control request received from the client is verified to be a control request made by an authenticated client having a suitable authorization level, the access control manager is configured to control the device through the corresponding virtual device, receive a control result from the device, and encrypt and transfer the control result to the client.

6. A method for controlling an access for a device on a home network, comprising:
storing a list of authentication codes including an authorization level and an authentication code configured for the device and a client requesting a service to the device;
receiving a device control request from the client;
authenticating the client having requested the device control request based on the list of authentication codes and verifying whether the device control request made by the client is suitable for the authorization level of the client;
transferring the control request to the requested device if the device control request made by the client is verified to be suitable for the authorization level of the client; and
receiving a control result for the control request from the device and transferring the control result to the client.

7. The method of claim 6, further comprising, once a device registration request is received from the device:
receiving the authentication code and the authorization level for the device from a security administrator;
generating a virtual device corresponding to the device;
generating a first encryption key for encrypted communication with the device;
storing the first encryption key in the virtual device; and
transferring the first encryption key to the device.

8. The method of claim 7, wherein the transferring of the control request to the requested device encrypting and transferring the control request by use of the first encryption key stored in the virtual device corresponding to the requested device.

9. The method of claim 6, further comprising, once a client registration request is received from the client:
receiving the authentication code and the authorization level for the client from a security administrator;
generating a second encryption key for encrypted communication with the client; and
transferring the second encryption key to the client.

10. The method of claim 9, wherein the step of receiving a control result for the control request from the device and transferring the control result to the client comprises encrypting the control result by use of the second encryption key and transferring the control result to the client.
